(19) United States
(12) Patent Application Publication
(10) Pub. No.: US 2020/0394036 A1
(43) Pub. Date: Dec. 17, 2020

(54) METHOD AND SYSTEM FOR INTEGRATING A DEVELOPMENT ENVIRONMENT REPOSITORY WITH A VERSION CONTROL TOOL

(71) Applicant: INSUM SOLUTIONS INC., Montreal (CA)

(72) Inventor: Vincent MORNEAU, Montreal (CA)

(21) Appl. No.: 16/900,073

(22) Filed: Jun. 12, 2020

Related U.S. Application Data
(60) Provisional application No. 62/861,624, filed on Jun. 14, 2019.

(51) Int. Cl. G06F 8/71; G06F 16/185; G06F 16/11

(52) U.S. Cl. CPC G06F 8/71; G06F 16/116; G06F 16/185

(57) ABSTRACT

A method for integrating a development environment repository with a version control tool comprises extracting, from the development environment repository, individual artifacts composing an application, sorting the individual artifacts into a hierarchical file structure, assigning a respective programming language to each artifact, and providing a visual display of the individual artifacts based on their respective programming languages. A system for integrating a development environment repository with a version control tool comprises an interface adapted for communicating with the development environment repository, a processor implementing the method, and a display device providing a visual display of the individual artifacts based on their respective programming languages.

### CROSS-REFERENCE

The present application claims priority to U.S. Provisional Patent Application No. 62/861,624, filed on Jun. 14, 2019, the entirety of which is incorporated herein by reference.

### TECHNICAL FIELD

The present disclosure relates to the field of software development tools. More specifically, the present disclosure relates to a method and a system for integrating a development environment repository with a version control tool.

### BACKGROUND

In many technologies that use a centralized repository to manage application artifacts, the development environment itself provides a central and unique management platform for artifacts and their lifecycles.

Centralized management ensures that the development environment is easy to use throughout the development lifecycle by providing the capability of monitoring application resources, by providing snapshots of an application state at any given point in time, and by limiting application dependency on external resources. An integrated development environment can be available as a desktop application or delivered as an application through a browser.

This centralized repository-based architecture facilitates the deployment and the operationality of an application based on such a platform which eases the learning, and adoption, of such a development environment. It is well adapted to an application lifecycle rooted in the waterfall methodology, where parallel development tracks are synchronized around a common timeline and deadline. Alternate methodologies have emerged, such as Agile, which promote the atomicity of the development activity into smaller units of work and increases the rate of delivery to clients.

As the rate of change increases, improvements are needed in conventional techniques used for managing the system artifacts, in regards to their modifications and their dependencies, and for maintaining control of the changes to an application.

### SUMMARY

The present disclosure details an approach that enables integration of a centralized repository-based development environment with an external tool, allowing users to work according to recommended development practices based on the lifecycle of individual artifacts.

### BRIEF DESCRIPTION OF THE DRAWINGS

Embodiments of the disclosure will be described by way of example only with reference to the accompanying drawings, in which:

FIG. 1 is an illustration of a version control tool context;

FIG. 2 illustrates use of an APEX environment in a version control system;

FIG. 3 is a repository example;

FIG. 4 is an input file example;

FIG. 5 illustrates a modified version control tool context;

FIG. 6 shows a simplified APEXcl export; and

FIG. 7 illustrates a generated folder structure or “file tree” in the APEXcl output files.

### DETAILED DESCRIPTION

### Context and Challenge

The present disclosure details an approach to enable integration of a centralized repository-based development environment with an external tool, to allow users to work according to recommended development practices based on the lifecycle of individual artifacts.
External specialized artifact lifecycle management tools are commonly used in the development process to manage changes to code over time and to account for ownership of those changes. These external tools (or systems) record changes to a file or set of files throughout the development lifecycle.
In traditional file-based development environments, the code for a project, application or software component is typically organized in a folder structure or “file tree”. Users work on external files which are compiled, merged and imported within the development environment. These files, which contain an application's individual artifacts, can be accessed by, and are used as an input to, external specialized artifact lifecycle management tools.
In the case of a centralized repository-based development environment, the fact that processing, data manipulation and business logic is executed directly within the integrated development environment significantly hinders the integration with external artifact lifecycle management tools.
   A first obstacle is the absence of a file structure containing individual artifacts found in traditional development environments, as file-based compilation is not required in a metadata-driven architecture where data is manipulated directly in the repository.
   A second obstacle resides in the closed-system nature of the centralized repository-based development environment. Individual artifacts within an application are controlled internally and are “hidden” within the system, creating a barrier to their visibility and accessibility.
   This absence of files and the inability to access individual artifacts within the system hinders the integration with external lifecycle management tools which rely on accessible files containing individual artifacts of a system.

One technological challenge comprises devising a solution that will, firstly, extract from the central and closed internal repository the system or application definition and, subsequently, structure and format the extracted output into a sufficiently granular hierarchical file format such as to allow integration with external specialized artifact lifecycle management tools.

### Integration Process

The integration process addresses the technological challenges as four key functions: (1) the extraction of individual artifacts from within the repository, (2) the breakdown and conversion of some proprietary artifacts not exportable as individual components, (3) the sorting of individual artifacts into a logical and hierarchical file structure, and (4) the display of the exported individual artifacts in their respective programming languages (for example JSON, SQL, JS, CSS, HTML, .txt . . . )
The integration process can be accessed by command line or through a user interface. The user interface can be as a stand alone application or integrated with the centralized repository system as a plugin.
The process interacts with the repository to extract artifacts. When extracting the artifact, the process introduces a hierarchical structure based on the logical structure in the application.
Some elements of the system, proprietary to the centralized repository-based environment, are not in a format which will allow the extraction process. The extraction process does not recognize these elements as artifacts or individual components. Since there is no existing native support (within the repository-based environment) to resolve this issue, a functionality has been introduced in the system to capture, bundle and convert these elements into individual artifacts, as extracted artifacts.
The extracted artifacts are imported and sorted into a file tree designed to reproduce the logical structure of a system (or application) and at a sufficiently granular level.

### Extracted Artifacts Creation

Certain artifacts, individual programming elements of the system which are created and managed by the repository, may not be available as individual artifacts. The disclosed process creates these components dynamically to allow eventual externalization.

The process analyzes the application and separates its components into logical elements to assign them as extracted artifacts.

The integration process assigns a name and a type to the extracted components.

The extracted artifacts are dynamically assigned within the application hierarchy to maintain their logical structure.

Each extracted artifact is assigned a programming language according to its purpose. Every dynamic component has a different purpose, and a programming language extension is attributed according to this purpose of the dynamic component.

The design of extracted components enables integration with external tools at a finer level than would otherwise be available using the repository functionality.

The extracted component provides a finer level for versioning, which can be integrated with the configuration management system, enabling versioning at a lower level within the application than through the repository. This could be leveraged to provide application lifecycle support, control, and security of changes at the extracted component level.

Appendices I and II describe various illustrative embodiments of the present technology. Some of these features may be present in some implementations and not in other implementations.

### APPENDIX 1: THE APEXcl PROCESS WITHIN THE ORACLE APEX TECHNOLOGY

### Overview

Unlike traditional file-based development environments, the conventional APEX technology from Oracle is designed as a centralized repository-based development environment, where processing, data manipulation and business logic is executed directly within the database. In such an architecture, each APEX application is deployed using a single export file containing the complete definition of the application.

The generated APEX Export file can be quite voluminous. Because of the nature of the SQL format, a very simple application can represent over 55K lines of code. The APEX Export file containing the APEX application definition is deployed alongside other scripts (DDL, packages, views, etc.) which need to be exported as well.

The APEX Export file has not been designed to be used with external lifecycle management (or version control) tools. Since the APEX Export file is the only output produced by the system which contains the code definition, it is currently used by developers as the input into external version control tools.

In its current state, the APEX Export file greatly limits the use of change management functionalities of version control tools, due to the lack of a file structure required by the external versioning tools.

APEXcl is a novel process which extracts the APEX application definition from the Oracle database, deconstructs and translates the code into individual components (or artifacts) and sorts the data into a clear, logical and hierarchical file structure which can be used as an input to external versioning software.

This document explains how APEXcl fits in the architecture of a typical APEX application deployment and version control process.

### I. Version Control Tools

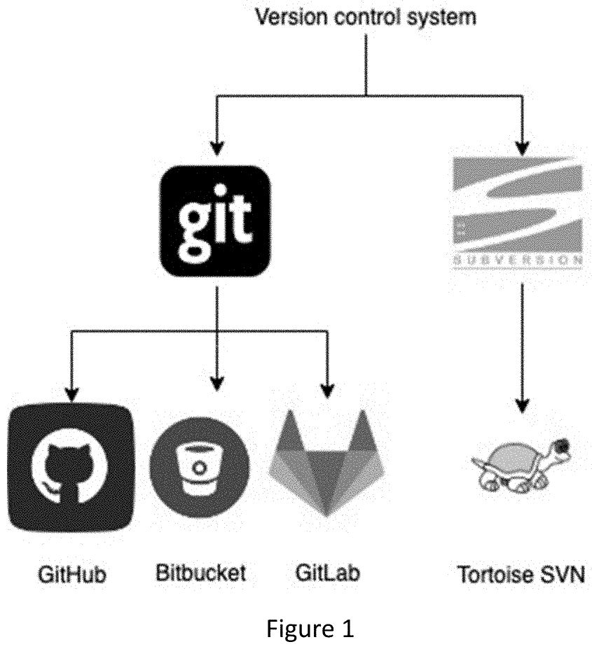

The context of version control tools is presented in FIG. 1.

Version Control Systems (VCS): A version control system is an architecture that records changes to a file or set of files throughout the development lifecycle. Popular version control systems are Git and SVN (Subversion). APEXcl is compatible with both systems.

Platforms: Hosting of these systems may be performed through platforms such as GitHub, BitBucket and GitLab for Git, and Tortoise for SVN. These platforms offer a number of functionalities useful in development lifecycle management, namely in facilitating code review, code control, and history management.

Client Applications: A client application will integrate Git into a user's operating systems. Examples would be Sourcetree, GitHub Desktop, Visual Studio Code, Tortoise SVN, etc.

For the purpose of keeping this documentation simple, one embodiment of the present technology uses Git as the VCS, hosted on the GitLab platform, using the client application Visual Studio Code.

### II. Deployment for a Typical APEX Application (Currently, without APEXcl)

### A. Generated Export Files

The deployment of a typical APEX application generally requires the generation of two sets of files:
1. The APEX application Export file
2. The DDL, packages, views, and other objects that are required for the app to function properly

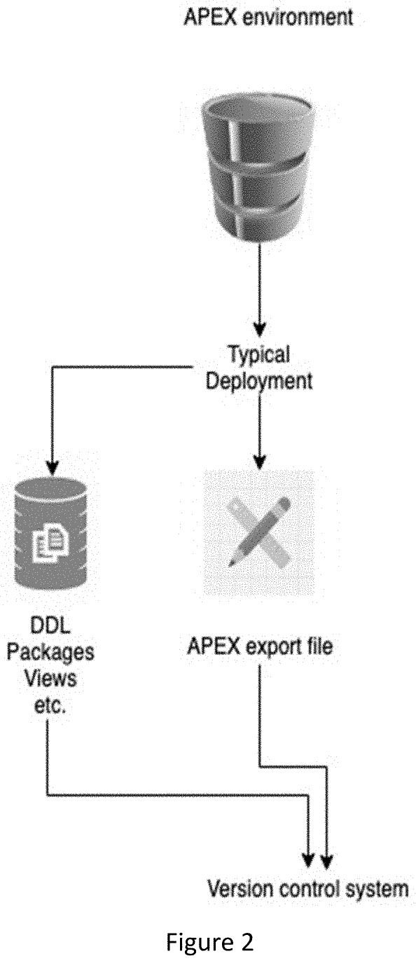

The files generated in the course of a deployment of the application are committed (or saved) on a VCS. FIG. 2 illustrates use of an APEX environment in a version control system.

### B. Repository Structure (without APEXcl)

A typical APEX repository on the version control system (VCS) platform can be structured in many ways, but recommended practice would have the repository organized by object types.

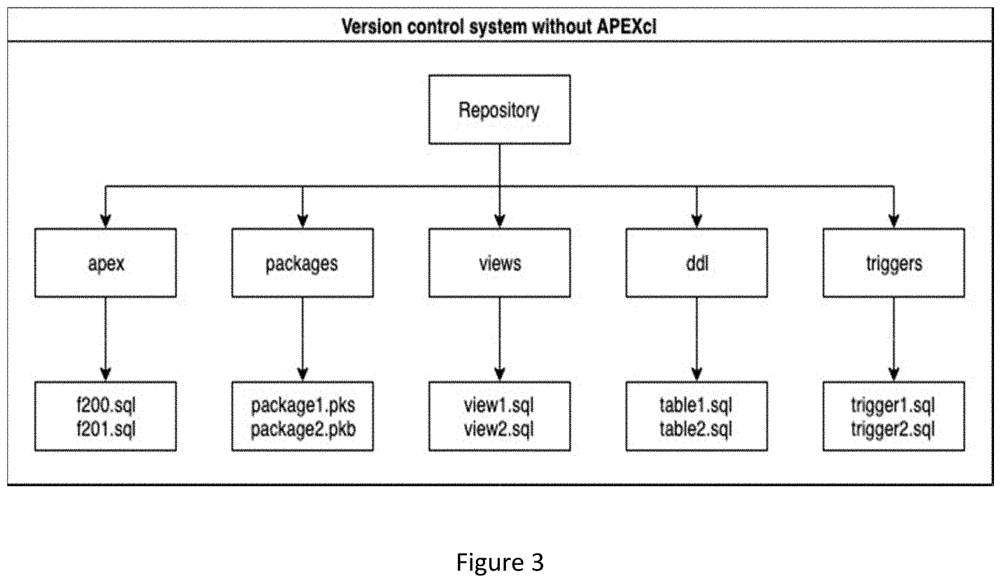

In the repository example of FIG. 3, there would be a release script that executes all objects required for the current deployment.

### C. Current Version Control Process

As an input, version control platforms use files which contain the individual artifacts of an application. In the case of Oracle APEX, such structured files are inexistent since processing, data manipulation and business logic are executed directly within the database. As such, the only output currently available to be used in a version control platform (input) is the APEX Export file.

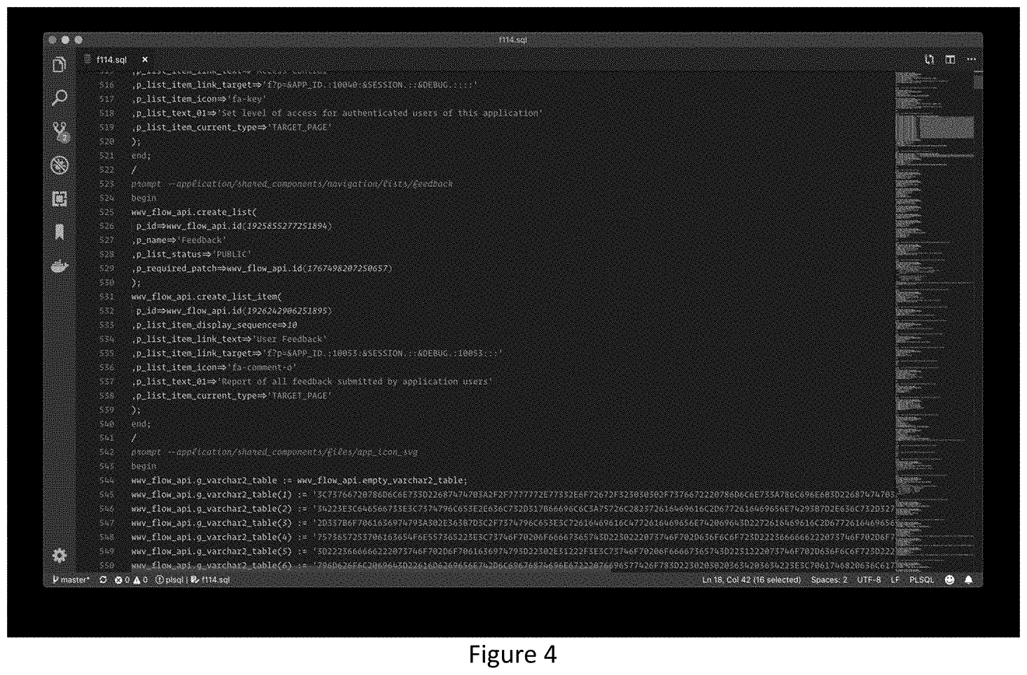

Input File: The APEX Export function generates a single voluminous SQL file that contains all the elements that exists inside the application: shared components, pages, regions, etc. This voluminous SQL file contains encoded characters and identification keys (IDs) that distract from the actual content of the application. It is not only hard to read and search, but since it is not logically structured, it does not allow to use most functionalities of version control software. An input file example is shown on FIG. 4.

### III. Deployment Process of an APEX Application with APEXcl

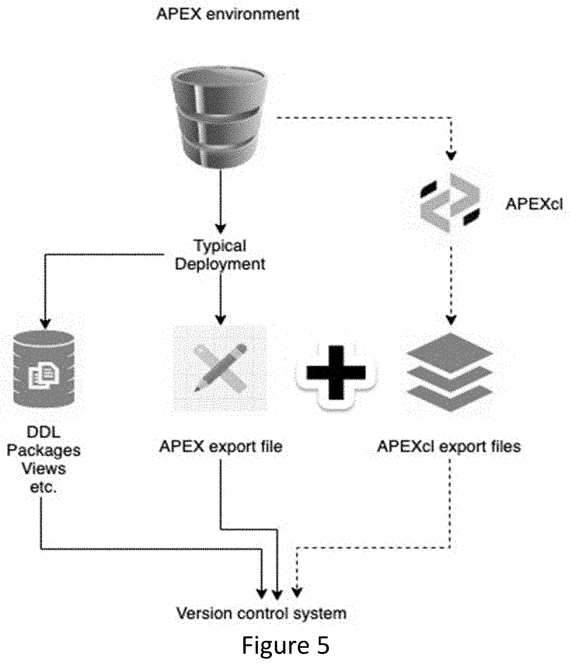

APEXcl does not replace the regular APEX export mechanism, but rather adds a new layer of information (files) to a conventional version control system repository. FIG. 5 illustrates a modified version control tool context.

### A. APEXcl Process

Each user (developer) installs APEXcl on his workstation. APEXcl connects to the same Oracle environment/database where the APEX application resides, extracts the application definition, and generates hundreds (or thousands) of smaller readable files structured in a folder tree. These generated files are in turn committed, or saved, on the same repository as the project.

### B. Repository Structure (with APEXcl)

The creation of an APEX directory at the root of the VCS repository is recommended. The APEXcl export can then be saved under an apexcl subdirectory.

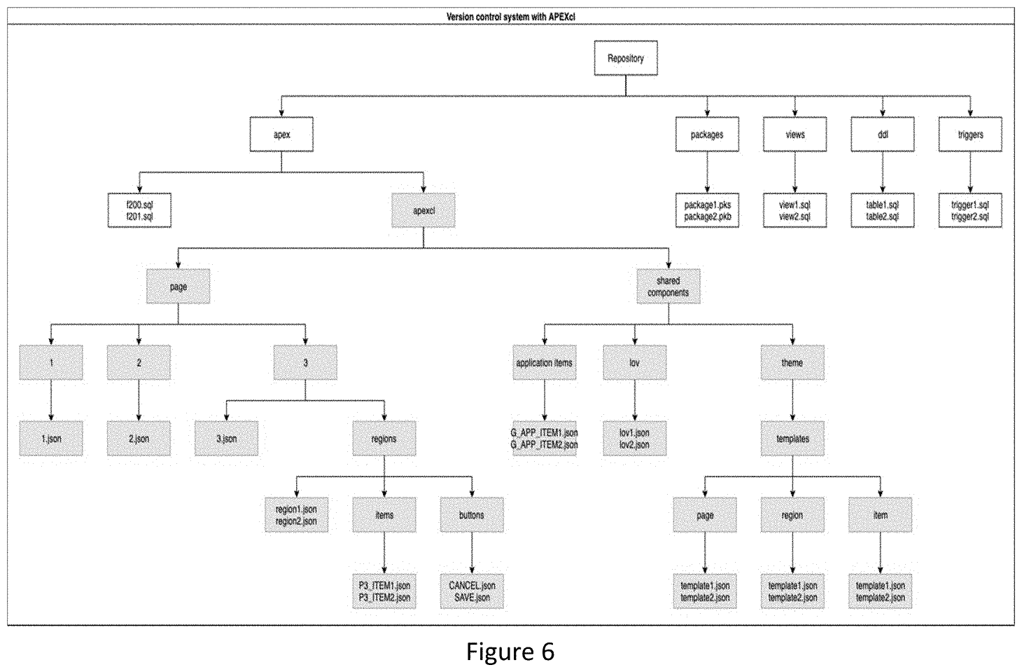

FIG. 6 shows a simplified APEXcl export. Thousands of files may be exported here.

### C. APEXcl Output (and Input into VCS Software)

The APEXcl process performs four key functions: (1) the extraction of individual artifacts of the APEX application within the Oracle database, (2) the breakdown and conversion of some Oracle APEX proprietary artifacts not exportable as individual components, (3) the sorting of individual artifacts into a logical and hierarchical file structure, and (4) the display of the exported individual artifacts in their respective programming language such as JSON, SQL, JS, CSS, HTML, .txt, and the like.

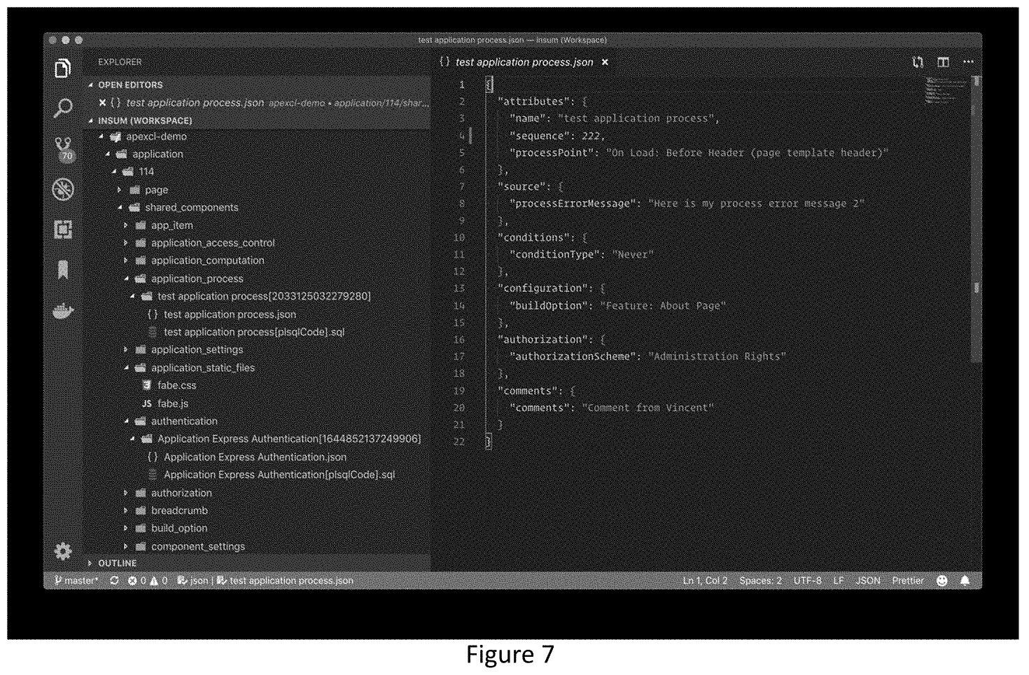

A generated folder structure or “file tree” in the APEXcl output files, as shown on FIG. 7, emulates the way the code for a project, application or software component is typically organized in traditional file-based development environments. It breaks down the code in a sufficiently granular level to enable the use of code management functionalities of VCS software.

Practices/tools/technologies
Tracking changes to components in relation to functional changes
Facilitating the components versioning
Integration of change management vs the component versioning
Business continuity vs application lifecycle
Automatic management of components in regards to the deployment
Code review of changes
Audit of automatic component evolution
Security of application components
Adoption of continuous integration practices
Facilitation of fault analysis in regard to application modifications

Architecture
Externalization of automatic components/dependencies management
Automatically organizes components in the hierarchical structure
Externalization of original file format/naming
Native custom externalization—components which are native to the development environment (i.e. pl/SQL)
Process integration to the repository of the externalized components

### APPENDIX 2: TECHNICAL BRIEF—THE APEXcl PROCESS

### APEXcl—Built for the Oracle APEX Development Platform

### Objective

APEXcl is a tool designed to create a software development folder or files containing hierarchically organized software project artifacts for database-integrated development platforms.

### Technological Challenge

1. Hidden code within a development platform—Oracle APEX Architecture
1.1 A low-code development platform (LCDP) is software that provides an environment used by programmers to create application software through graphical user interfaces and configuration instead of traditional computer programming. Low-code development platforms reduce the amount of traditional hand coding, enabling accelerated delivery of business applications. LCDPs are based on the principles of model-driven design, automatic code generation, and visual programming (https://en.wikipedia.org/wiki/Low-code development platform)
1.2 Oracle APEX (“APEX”) is a low-code, high-productivity development tool that is architecturally integrated to the Oracle database. The Oracle APEX engine runs in the Oracle database. SQL requests coming from APEX are processed by the Oracle database with zero latency, as the APEX mid-tier is in effect a pass-through, serving as a proxy for browser requests directed toward the database.
1.3 Web applications built using the low-code platform APEX, though created with minimal code writing by developers, will be comprised of thousands of lines of code across numerous different programming languages. In effect, a large part of the application may be built with “hidden” code, embedded within the platform.
1.4 One main technological challenge to creating a software development folder lies in the centralized, hidden nature of the components or artifacts.

### APEXcl Constitutive Components

2. Identifying and defining artifact types
2.1 An artifact is one of many kinds of tangible by-products produced during the development of software. Navigation bars, page footers and individual text fields of a typical web page are all artifact examples. An APEX application at runtime may be constituted of over a hundred types of artifacts.
2.2 Each artifact is made up of a number of properties, such as, for example, a “label”, a “width” and a “maximum number of characters”. Each type of artifact can have over 100 properties.
2.3 A complete definition was made of all constituent artifacts of an APEX application, including their respective properties.

3. Establishing the file hierarchy structure and defining hierarchy rules
3.1 In creating the file structure, the hierarchy structure of artifacts is established and hierarchy rules are defined. For instance, a text field belongs to a region which belongs on a page which belongs to an application.
3.2 The 100+ types of artifacts found in a typical APEX application are categorized into three types, each requiring a different hierarchy approach and rules.
   3.2.1 Type I—Regular: For regular artifacts, the “Connect by” clause in Oracle is used to link all parents and children artifacts in the correct order.
   3.2.2 Type II—Dynamic: Certain artifacts cannot be linearly organized due to their dynamic hierarchical nature. For instance, a region can belong to another region, which in turn belongs to another region. The dynamicity of region hierarchy can result in a number of levels ranging from one level to several hundred or thousand levels. This dynamic hierarchy is represented through folder-in-folders on the file system.
   3.2.3 Type III—“Orphan” artifacts: In the context of an APEX application, certain artifacts are identified as having no parents and no dependents. An “application process”, for example, is an orphan artifact. These artifacts are effectively positioned at the first AND last level of a hierarchy.

4. Dynamic programming language export
4.1 The APEX development allows coding in several different programming languages. SQL and PL/SQL are the primary languages used, along with JavaScript, CSS, HTML.
4.2 Code written in different languages may be found in various artifacts and in the various properties of those artifacts. The extraction process has been conceived to recognize the individual code language and ensure filing in the correct file type.
   SQL and PL/SQL properties=SQL file
   JavaScript properties=JavaScript file
   HTML properties=HTML file
   CSS properties=CSS file
4.3 Code in the APEXcl output files will be displayed in the intended language.
4.4 A property that is not specific to a programming language is displayed in the JSON (JavaScript Object Notation) language.

5. APEXcl dictionary
5.1 The APEXcl dictionary comprises a set of tables that define elements (artifacts types and their properties) that are to be extracted from the APEX application as well as a sequence of extraction of these elements.
5.2 Element Data: Each element in the dictionary contains, amongst others, a table name reference and a column name reference which refer to the location of the elements in the Oracle Database. These references are used in the query process.
5.3 Dynamic Properties: Dynamic properties are artifact properties created according to a rule. For instance, for an artifact of type “page”, a dynamic property would be created on the condition that the page contain code written in the JavaScript language. If the logical test returns a TRUE value, the additional property containing the actual JavaScript code is created. If the logical test returns a FALSE value, no property is created.
5.4 Sequence of Extraction: The dynamicity logic applies to thousands of properties across dozens of artifact types. Each of these properties is programmed within APEXcl by mimicking the APEX artifact properties logic from the APEX builder.

### Extraction Process

6. STEP 1: Access to the Oracle Database Setting Process
6.1 To provide coverage for 100+ types of artifacts and properties, an access to read directly from the APEX table is used.
6.2 To create a secure access to the tables, the APEXcl database installation process creates a special schema, named “apexcl”, which has read access to the proper APEX schema (ex.APEX_190100 for APEX version 19.1). Once created, the schema will act as a “door” to the Oracle database.
6.3 Within the new apexcl schema, a view is created for each of the 100+ artifact types. To limit other workspaces to only access the data from their parsing schemas, security is applied on the views. The security logic used for APEXcl views emulates the security logic applied to the existing APEX views regarding workspace permissions.
6.4 Once the “secured door” has been created, the apexcl schema is granted the correct APEX parsing schema. Once granted, APEXcl will be executable to any user with regular access to APEX.

7. STEP 2: APEX Version Recognition Process
7.1 Over the different versions of the APEX development tool, changes have been brought to the nature of certain artifacts. These changes in artifacts are reflected in the APEXcl artifact dictionary used in the extraction process.
7.2 Unique APEXcl dictionaries have been created for each APEX version, starting at APEX version 5.1.
7.3 In the extraction process, the “apex_application.g_flow_schema_owner” API is invoked to ascertain the APEX version, which allows the identification and loading of the appropriate APEXcl dictionary.

8. STEP 3: Database Query Process
8.1 Connection: node-oracledb is used to connect the command-line utility APEXcl to the Oracle Database. node-oracledb is used as it enables the pooling of a dynamic number of connections at a single time.
8.2 Authentication: Once a pool of connections is created, an authentication into the “secured door” is performed to restrict the access to only the user's data. Authentication is performed by altering the database session and setting the current schema to the APEXcl schema.
8.3 Session: A command is sent to simulate an APEX session using the APEX_SESSION.CREATE_SESSION API. This step constitutes the final security “handshake” done to ensure the data integrity.
8.4 Application Data Generation: With the user securely authenticated, the Oracle database is queried using generated SQL from the relevant-version APEXcl dictionary which contains the names of the tables to query and their associated column names.
8.5 Parsing: The artifact data is parsed through JSON and ready to be saved into a file, on the file system. The APEXcl constitutive components allow to determine the artifact type (section 2), the hierarchy level (section 3), the appropriate language (section 4), the properties to extract (section 5), the filename (section 9) as well as the special grid layout properties (section 10).

9. STEP 4: Artifact Naming Process
9.1 Duplicate File Names Conversion: Unlike operating systems (macOS, Windows, Linux), where naming conventions ensure that no two artifacts will have the same name, database systems may allow same-name artifacts. For instance, in APEX, three regions contained on the same page may have the same name. Duplicate names may cause conflicts in version control systems and compatibility issues with different operating systems. An initial process is enacted to search and find duplicate file names at a same level. A sequential number is appended to each duplicate file name, creating unique file names.
9.2 Prohibited Symbol Conversion: Certain symbols and characters, such as “:”, “<” or “*”, found in APEX artifact names may be prohibited from operating systems. The prohibited, or invalid, symbols may vary across different operating system. The exact blacklist of prohibited symbols across different operating systems is defined in APEXcl. A symbol conversion process is enacted to remove prohibited symbols from filenames.
9.3 Capital Letter Conversion: Table and column names are usually displayed in uppercase within the database. To ensure interoperability, the camelCase naming convention is used. A filename conversion process is enacted to convert capitalized names using the camelCase convention.

10. STEP 5: Grid Properties and Element Positioning Process
10.1 In the web development process, element positioning impacts user interface (UI) and user experience (UX). Typically, a grid layout is used, where cells are structured in rows and columns. Developers will place components into cells (most being invisible cells).
10.2 APEX uses such a grid layout system. Three types of artifacts use a grid layout: regions, items and buttons. Positioning of the element will be registered in its properties.
10.3 Five properties have been identified, and which are relevant in establishing the position on the web page of the three types of artifacts: (1) Artifact has grid support, (2) Artifact is on a new row, (3) Artifact is on a new column, (4) Artifact spans across X columns and (5) Artifact start at X column.
10.4 The relative position of multiple artifacts in the same grid is also considered. The grid layout properties of an artifact are influenced by the neighbouring artifacts.
10.5 The APEXcl process results in a conditional displaying of properties, in order to show only those that are relevant to their relative position on the web page.

### Conclusion

Those of ordinary skill in the art will realize that the description of the method and system for integrating a development environment repository with a version control tool are illustrative only and are not intended to be in any way limiting. Other embodiments will readily suggest themselves to such persons with ordinary skill in the art having the benefit of the present disclosure. Furthermore, the disclosed method and system may be customized to offer valuable solutions to existing needs and problems related to maintaining control of changes to an application. In the interest of clarity, not all of the routine features of the implementations of the method and system are shown and described. In particular, combinations of features are not limited to those presented in the foregoing description as combinations of elements listed in the appended claims form an integral part of the present disclosure. It will, of course, be appreciated that in the development of any such actual implementation of the method and system, numerous implementation-specific decisions may need to be made in order to achieve the developer's specific goals, such as compliance with application-related, system-related, network-related, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of software development tools having the benefit of the present disclosure.

In accordance with the present disclosure, the components, process operations, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations is implemented by a computer, a processor operatively connected to a memory, or a machine, those operations may be stored as a series of instructions readable by the machine, processor or computer, and may be stored on a non-transitory, tangible medium.

Systems and modules described herein may comprise software, firmware, hardware, or any combination(s) of software, firmware, or hardware suitable for the purposes described herein. Software and other modules may be executed by a processor and reside on a memory of servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

What is claimed is:

1. A method for integrating a development environment repository with a version control tool, comprising:
extracting, from the development environment repository, individual artifacts composing an application;
sorting the individual artifacts into a hierarchical file structure;
assigning a respective programming language to each artifact; and
providing a visual display of the individual artifacts based on their respective programming languages.

2. The method of claim 1, wherein the hierarchical file structure based on a logical structure in the application under development.

3. The method of claim 1, wherein the respective programming language are assigned to each given artifact according to a functional purpose of the given artifact.

4. The method of claim 1, further comprising:
identifying a subset of the individual artifacts that are not sortable into the hierarchical file structure; and
converting the individual artifacts of the subset prior to their sorting in the hierarchical file structure.

5. The method of claim 4, wherein the hierarchical file structure based on a logical structure in the application under development.

6. The method of claim 4, wherein the respective programming language are assigned to each given artifact according to a functional purpose of the given artifact.

7. A system for integrating a development environment repository with a version control tool, comprising:
an interface adapted for communicating with the development environment repository;
a processor operatively connected to the interface, the processor being configured to:
cause the interface to extract, from the development environment repository, individual artifacts related to an application,
sort the individual artifacts into a hierarchical file structure,
assign a respective programming language to each artifact; and
a display device operatively connected to the processor, the display device being configured to provide a visual display of the individual artifacts based on their respective programming languages.
